(19) United States
(12) Patent Application Publication
(10) Pub. No.: US 2014/0004902 A1
(43) Pub. Date: Jan. 2, 2014

(54) MOBILE PHONE WITH DETACHABLE FUNCTIONAL MODULES

(71) Applicant: HON HAI PRECISION INDUSTRY CO., LTD., New Taipei (TW)

(72) Inventor: JEN-TSORNG CHANG, New Taipei (TW)

(73) Assignee: HON HAI PRECISION INDUSTRY CO., LTD., New Taipei (TW)

(21) Appl. No.: 13/849,532

(22) Filed: Mar. 24, 2013

(30) Foreign Application Priority Data
Jun. 29, 2012 (TW) 101123565

(51) Int. Cl. H04M 1/02

(52) U.S. Cl. CPC H04M 1/0254
USPC 455/557

(57) ABSTRACT

A mobile phone includes a phone call module for making and answering a phone call, a touch control module detachably connected to the phone call module and a shooting module detachably connected to the phone call module. The phone call module includes a first wireless communication terminal and a second wireless communication terminal. The touch control module allows to operate the phone call module by a touch control manner The touch control module includes a third wireless communication terminal, and the touch control module establishes a wireless communication with the phone call module by the first wireless communication terminal and the third wireless communication terminal The shooting module includes a fourth wireless communication terminal, and the shooting module establishes a wireless communication with the phone call module by the second wireless communication terminal and the fourth wireless communication terminal.

### BACKGROUND

1. Technical Field

The present disclosure relates to mobile phones and, particularly, to a mobile phone with a number of detachable functional modules.

2. Description of Related Art

Nowadays, a mobile phone is integrated with a variety of functions, such as functions of making/answering a phone call, image/video shooting, touch control, wireless networking, for example. However, such functions require additional hardware modules and thus increase the size of the mobile phone, disabling the mobile phone ability to meet the portability requirement. In addition, in some predetermined situations, some functions of the mobile phone may not be enabled.

What is needed therefore is a mobile phone addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic and exploded view of a mobile phone, according to an exemplary embodiment of the present disclosure, the mobile phone including a phone call module, a touch control module, and a shooting module.

FIG. 2 is a schematic view of the touch control module.

FIG. 3 is an assembled view of the phone call module and the touch control module of the mobile phone of FIG. 1.

FIG. 4 is an assembled view of the phone call module and the shooting module of the mobile phone of FIG. 1.

FIG. 5 is an assembled view of the phone call module, the touch control module and the shooting module of the mobile phone of FIG. 1.

### DETAILED DESCRIPTION

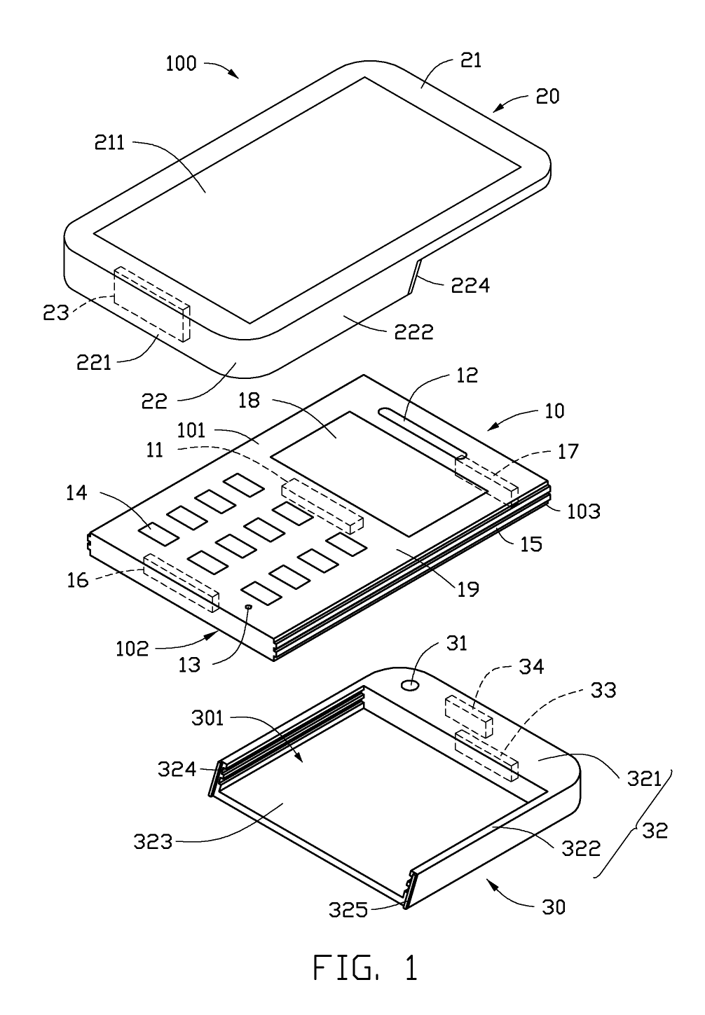

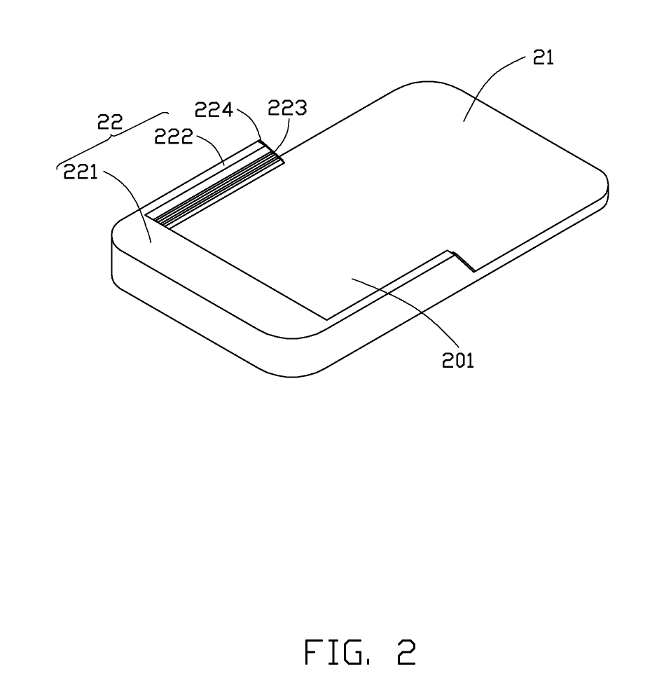

FIGS. 1-2 show a mobile phone 100 according to an exemplary embodiment. The mobile phone 100 includes a phone call module 10, a touch control module 20, and a shooting module 30.

The phone call module 10 is configured for making/answering a phone call. The phone call module 10 is substantially rectangular. The phone call module 10 includes a first surface 101, a second surface 102 opposite to the first surface 101, and two side surfaces 103 connected the first and second surfaces 101, 102.

The phone call module 10 includes a processor unit 11, a telephone receiver unit 12, a microphone unit 13, and a number of keys 14. The processor unit 11 is positioned in a shell 19 of the phone call module 10, and the processor unit 11 is configured for processing phone call signals, video/audio signals, and running an operation system. In detail, the processor unit 11 comprises an independent baseband processor chip and an application processor chip, or the processor unit 11 may be a chip integrated with a baseband processor and an application processor. The telephone receiver unit 12 and the microphone unit 13 are positioned at two opposite ends of the phone call module 10. The telephone receiver unit 12 is configured for converting electrical signals into sounds and transmitting the sounds out of the phone call module 10. The microphone unit 13 is configured for converting sounds into corresponding electrical signals and transmitting the electrical signals to the processor unit 11. The electrical signals are processed by the processor unit 11 and are wirelessly transmitted out of the phone call module 10. The keys 14 serve as an information input interface, for a user to input information through the keys 14, such as dialing numbers, editing short messages, for example. The phone call module 10 further includes two pairs of guiding rails 15. Each pair is formed on a side surface 103. The phone call module 10 further includes a first wireless communication terminal 16 and a second wireless communication terminal 17. The first wireless communication terminal 16 is positioned in the phone call module 10 adjacent to the microphone unit 13, and the second wireless communication terminal 17 is received in the phone call module 10.

The phone call module 10 further includes a screen 18 for displaying input/output information.

The touch control module 20 allows touching operations. The touch control module 20 includes a touch panel 21, a first holding member 22 connected to the touch panel 21 and a third wireless communication terminal 23. The touch panel 21 provides a touch control interface, and the touch panel 21 includes a touch screen 211 for displaying visual operation, characters, and/or other patterns. The touch screen 211 can be selected from one of resistive touch screen, surface acoustic wave touch screen, and capacitive sensing touch screen. The first holding member 22 is configured for holding the phone call module 10. The first holding member 22 includes a first end wall 221 and two parallel first sidewalls 222 connected to the first end wall 221. The first end wall 221, the first sidewalls 222 and the touch panel 21 cooperatively define a first receiving space 201 therebetween. An inner surface of each first sidewall 222 defines two parallel first guiding grooves 223 corresponding to the guiding rails 155. Each first sidewall 222 includes a first locking member 224 formed on an end thereof away from the first end wall 221. The third wireless communication terminal 23 is corresponding to the first wireless communication terminal 16, thus a wireless communication can be established between the third wireless communication terminal 23 and the first wireless communication terminal 16. In this embodiment, the third wireless communication terminal 23 is positioned in the first end wall 221.

The shooting module 30 includes a camera unit 31 and a second holding member 32. The camera unit 31 allows the capturing of images and/or videos. The second holding member 32 includes a second end wall 321, two parallel second sidewalls 322 connected to the second end wall 321 and a bottom plate 323. The second sidewalls 322 and the second end wall 321 are substantially perpendicular to the bottom plate 323. The second end wall 321, the second sidewalls 322 and the bottom plate 323 cooperatively define a second receiving space 301 therebetween. An inner surface of each second sidewall 322 defines two parallel second guiding grooves 324 corresponding to the guiding rails 15. In this embodiment, the camera unit 30 is positioned on the second end wall 321. Each second sidewall 322 includes a second locking member 325 formed on an end thereof away from the second end wall 321 and each second locking member 325 is corresponding to a first locking member 224. The touch control module 20 and the shooting module 30 can be firmly connected to each other by the first locking members 224 and the second locking members 325. In this embodiment, the first locking members 224 and the second locking members 325 are magnets. The shooting module 30 includes a fourth wireless communication terminal 33 corresponding to the second wireless communication terminal 17, thus a wireless communication can be established between the second wireless communication terminal 17 and the fourth wireless communication terminal 33. In this embodiment, the fourth wireless communication terminal 33 is positioned in the second end wall 321.

In this embodiment, the first wireless communication terminal 16 communicates with the third wireless communication terminal 23, and the second wireless communication terminal 17 communicates with the fourth wireless communication terminal 33 by near field communication (NFC).

The shooting module 300 further includes a wireless network terminal 34. The wireless network terminal 34 allows wireless linkage to networks. In this embodiment, the wireless network terminal 34 is positioned on the second end wall 321. The wireless network terminal 34 can be linked to networks by wireless technology such as wireless fidelity (WiFi) or long term evolution (LTE), for example.

The mobile phone 100 can be used in different combinations of the phone call module 10, the touch control module 20 and the shooting module 30 according to different demands. In detail, the phone call module 10 can make/answer a phone call, and can be used alone. The phone call module 10 also can be used with a combination of the touch control module 20 and/or the shooting module 30.

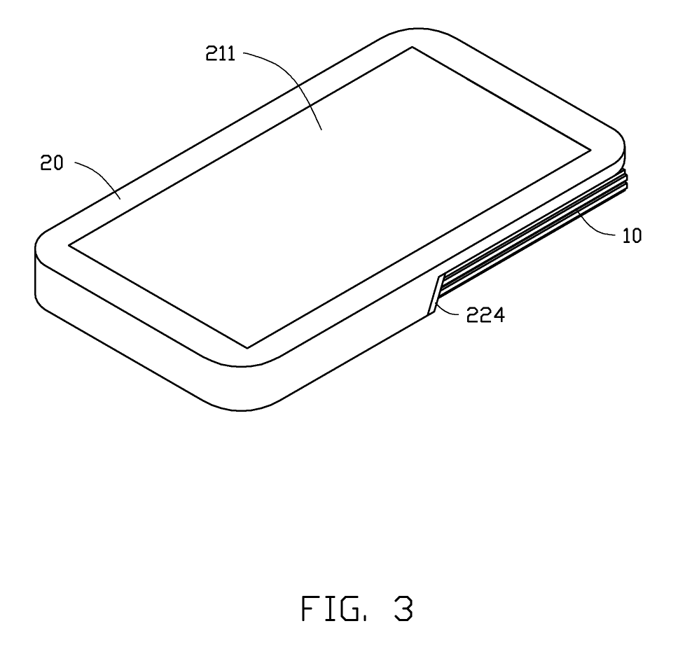

FIG. 3 shows that when a combination of the phone call module 10 and the touch control module 20 is needed, an end with the first wireless communication terminal 16 of the phone call module 10 is inserted into the first receiving space 201, and the guiding rails 15 are engaged into the first guiding grooves 223, respectively. When the phone call module 10 slides to the first end wall 221 along the first guiding grooves 223, a wireless communication can be established between the phone call module 10 and the touch control module 20 by the first wireless communication terminal 16 and the third wireless communication terminal 23. The phone call module 10 and the touch control module 20 can be fixed to each other by a common fixing means (not shown).

When a wireless communication is established, the phone call module 10 and the touch control module 20 can be used in combination, in detail, the touch control module 20 can control the phone call module 10 to make a call, edit short messages, and/or operate other application programs. Further, when a wireless communication is established, the power of the screen 18 is turned off, and input/output information is displayed on the touch screen 211.

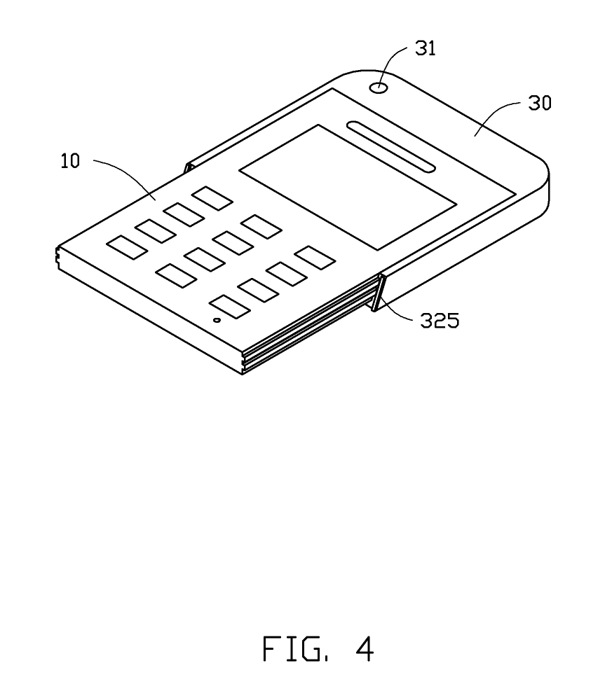

FIG. 4 shows that when a combination of the phone call module 10 and the shooting module 30 is needed, an end with the second wireless communication terminal 17 of the phone call module 10 is inserted into the second receiving space 301, and the guiding rails 15 are engaged into the second guiding grooves 324, respectively. When the phone call module 10 slides to the second end wall 321 along the first guiding grooves 223, a wireless communication can be established between the phone call module 10 and the shooting module 30 by the second wireless communication terminal 17 and the fourth wireless communication terminal 33. The phone call module 10 and the shooting module 20 can be fixed to each other by a fixing means (not shown).

When a wireless communication is established, the phone call module 10 and the shooting module 20 can be used in combination, in detail, the phone call module 10 can control the shooting module 30 to capture images/videos, and/or link to networks.

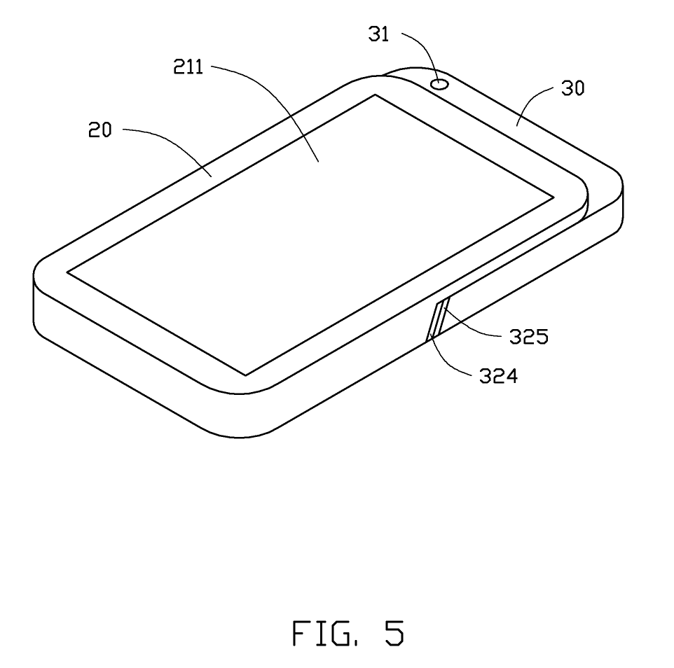

FIG. 5 shows that when a combination of the phone call module 10, the touch control module 20 and the shooting module 30 is needed, the phone call module 10, the touch control module 20 and the shooting module 30 can be connected to each other by the manners of FIGS. 3-5. When the phone call module 10, the touch control module 20 and the shooting module 30 are connected to each other, the first locking member 224 and the second locking member 325 are attached to each other to lock the combination of the phone call module 10, the touch control module 20 and the shooting module 30.

A wireless communication can be established between the phone call module 10 and the touch control module 20 by the first wireless communication terminal 16 and the third wireless communication terminal 23. In addition, a wireless communication can be established between the phone call module 10 and the shooting module 30 by the second wireless communication terminal 17 and the fourth wireless communication terminal 33.

In the embodiment, the above described phone call module 10, touch control module 20 and shooting module 30 each have a battery unit (not shown) for providing power. Alternatively, the touch control module 20 and the shooting module 30 can share the power of the battery unit of the phone call module 10, in this case, the touch control module 20 and the shooting module 30 each have an electrical connecting unit (not shown) for electrically connecting to the battery unit of the phone call module 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A mobile phone, comprising:
a phone call module configured for making and answering a phone call, the phone call module comprising a first wireless communication terminal and a second wireless communication terminal;
a touch control module detachably connected to the phone call module for allowing to operate the phone call module by the touch control module, the touch control module comprising a third wireless communication terminal corresponding to the first wireless communication, and the touch control module establishing a wireless communication with the phone call module by the first wireless communication terminal and the third wireless communication terminal; and
a shooting module detachably connected to the phone call module for capturing images and videos, the shooting module comprising a fourth wireless communication terminal corresponding to the second wireless communication terminal, and the shooting module establishing a wireless communication with the phone call module by the second wireless communication terminal and the fourth wireless communication terminal.

2. The mobile phone of claim 1, wherein the phone call module comprises a processor unit, a telephone receiver unit, a microphone unit and a plurality of keys, the processor unit is positioned in the phone call module, and the telephone receiver unit and the microphone unit are positioned at two opposite ends of the phone call module, respectively.

3. The mobile phone of claim 1, wherein the phone call module comprises two pair of guiding rails protruding from two opposite side surfaces, respectively; the touch control module defines parallel first guiding grooves for engaging with the guiding rails.

4. The mobile phone of claim 3, wherein the touch control module comprises a touch panel and a first holding member connected to the touch panel, and the first holding member is configured for holding the phone call module.

5. The mobile phone of claim 4, wherein the first holding member comprises a first end wall and two parallel first sidewalls connected to the first end wall, all of the first end wall, the first sidewall and the touch panel cooperatively define a first receiving space therebetween, and the first receiving space receives the phone call module when the touch control module is mounted on the phone call module.

6. The mobile phone of claim 5, wherein an inner surface of each first sidewall defines two of the parallel first guiding grooves corresponding to a respective one of the guiding rails, and the guiding rails are slid into the guiding grooves when the touch control module is mounted on the phone call module.

7. The mobile phone of claim 6, wherein the shooting module comprises a camera unit and a second holding member for holding the phone call module.

8. The mobile phone of claim 7, wherein the second holding member comprises a second end wall, two parallel second sidewalls and a bottom plate, the two parallel second sidewalls are connected to the second end wall, all of the second end wall, the second sidewalls and the bottom plate cooperatively define a second receiving space therebetween, and the second receiving space receives the phone call module when the shooting module is mounted on the phone call module.

9. The mobile phone of claim 8, wherein an inner surface of each second sidewall defines two parallel second guiding grooves corresponding to the guiding rails, and the guiding rails are slid into the second guiding grooves when the shooting module is mounted on the phone call module.

10. The mobile phone of claim 9, wherein each first sidewall comprises a first locking member on an end thereof away from the first end wall, each second sidewall comprises a second locking member on an end thereof away from the second end wall, each second locking member is corresponding to a respective first locking member, the touch control module and the shooting member are locked to each other by the first locking members and the second locking members when the touch control module and the shooting module are mounted on the phone call module.

11. The mobile phone of claim 10, wherein the first locking members and the second locking members are magnets.

12. The mobile phone of claim 9, wherein the shooting module comprises a wireless network terminal for allowing the shooting module to link to networks in a wireless manner.

13. A mobile phone, comprising:
a phone call module configured for making and answering a phone call, the phone call module comprising a shell, a first wireless communication terminal and a second wireless communication terminal;
a first function module detachably connected to the shell, the first function module comprising a third wireless communication terminal corresponding to the first wireless communication, and the first function module establishing a wireless communication with the phone call module by the first wireless communication terminal and the third wireless communication terminal; and
a second function module detachably connected to the shell, the second function module comprising a fourth wireless communication terminal corresponding to the second wireless communication terminal, and the second function module establishing a wireless communication with the phone call module by the second wireless communication terminal and the fourth wireless communication terminal.

14. The mobile phone of claim 13, wherein the phone call module comprises two pair of guiding rails protruding from two opposite side surfaces, respectively; the first function module defines parallel first guiding grooves for engaging with the guiding rails.

15. The mobile phone of claim 13, wherein the phone call module comprises two pair of guiding rails protruding from two opposite side surfaces, respectively; the second function module defines parallel second guiding grooves for engaging with the guiding rails.
